(19) United States
(12) Patent Application Publication
(10) Pub. No.: US 2025/0172582 A1
(43) Pub. Date: May 29, 2025

(54) METHOD FOR MEASURING THE SPEED OF A VEHICLE

(71) Applicant: Transport Analysis LTD, London (GB)

(72) Inventors: Samuel Bailey, London (GB); Mark Steadman, Kent (GB)

(21) Appl. No.: 18/837,420

(22) PCT Filed: Feb. 8, 2023
(86) PCT No.: PCT/GB2023/050290

§ 371 Date: Aug. 9, 2024

(30) Foreign Application Priority Data
Feb. 9, 2022 (GB) 2201646.3
Feb. 10, 2022 (GB) 2201730.5

(51) Int. Cl. G01P 3/68; G06T 7/246; G06T 7/73

(52) U.S. Cl. CPC G01P 3/68; G06T 7/248; G06T 7/74; G06T 2207/10016; G06T 2207/30236; G06T 2207/30248

(57) ABSTRACT

A method for measuring the speed of a vehicle from a video motion capture by using the time elapsed between a first wheel of the vehicle reaching a reference position in the image and a second wheel of the vehicle reaching the reference position in an image.

This invention provides additional features and inventions to the disclosure of PCT/GB2021/052516 (hereinafter referred to as the “earlier application”).

The following description comprises a recitation of the disclosure of the earlier application followed by a description of the new features and inventions subject of this application.

### DISCLOSURE OF THE EARLIER APPLICATION

This invention relates to a method for measuring the speed of a vehicle from a video capture measuring the speed of moving vehicles is desirable for law enforcement and traffic enforcement across the globe. Excessive speed is a significant cause of road accidents and leads to higher pollution and CO2 emissions from vehicles.

Devices exist for measuring vehicle speeds, speed cameras. These are ubiquitous and use typically use a doppler shift method whereby a beam of either radio waves (radar based) or light (lidar based) is emitted by the device, and the frequency shift of the reflected beam is used to determine the speed of a target relative to the emitter. They usually also include a camera, which is triggered by the doppler shift measurement, to take an image or video of the vehicle for number plate capture and enforcement.

It would be desirable to be able to determine the vehicle speed purely from the video capture. This would eliminate the need for the lidar or radar sensor, which adds cost and complexity to the speed camera. It also limits the deployment of the speed camera.

Some techniques for measuring vehicle speed from a video capture. However, they are of limited accuracy, and require some precalibration step.

These techniques capture an image of a moving vehicle and attempt to estimate speed. The problem in measuring vehicle speed from a video capture is the translation from pixels per second in an image to metres per second in the real world.

A target vehicle can be tracked across an image using computer vision techniques known in the field, e.g., optic flow, neural networks, Kalman filters. This yields a vehicle velocity in pixels per second across a field of view.

Alternatively, vehicle foreshortening can be measured. This yields a relative change in vehicle apparent size in the image.

The translation between pixels per second and meters per second is dependent upon several factors: the distance to the target vehicle from the camera, the camera Field of View angle (FoV), the degree of spherical aberration on the lens, the position of the vehicle within the field of view due to perspective shift.

Attempts to overcome these have previously relied on either physically measuring the distance to the vehicle or estimating it which induces errors and are difficult to validate. Alternatively, they rely on marking fixed positions on the road, e.g., a series of stripes painted at fixed intervals, and measuring the vehicle position in each frame relative to the stripes.

These all mean that a video speed camera needs to be set up in a fixed location, which adds expense, or is of limited accuracy. Other attempts to determine vehicle speed from video images include:
Determining speed of rotation of a vehicle wheel and using the circumference of the wheel and rate of wheel rotation to provide speed [US2019/0355132]
Creating a model between physical position co-ordinates and image position co-ordinates, using fixed features of vehicles [e.g., wheelbase] to provide calibration of parameters in the model [CN109979206A].

The present disclosure provides a method that can accurately capture vehicle speed from an image capture without any knowledge of the camera lens, vehicle distance, scene geometry and with no fixed position markers.

The invention provides a method for determining the speed of a vehicle in a video sequence, wherein a time elapsed between a first wheel of the vehicle reaching a reference position in the image and a second wheel of the vehicle reaching the reference position in the image is determined, the speed of the vehicle being calculated based on knowledge of the distance between the wheels of the vehicle and time elapsed.

In essence, the wheelbase of the vehicle being measured is used as a scaling factor to determine the speed in real world units from the time between a first wheel and a second wheel reaching a reference position on the image.

The invention is illustrated by way of example in the following exemplary and non-limitative description with reference to the drawings in which:

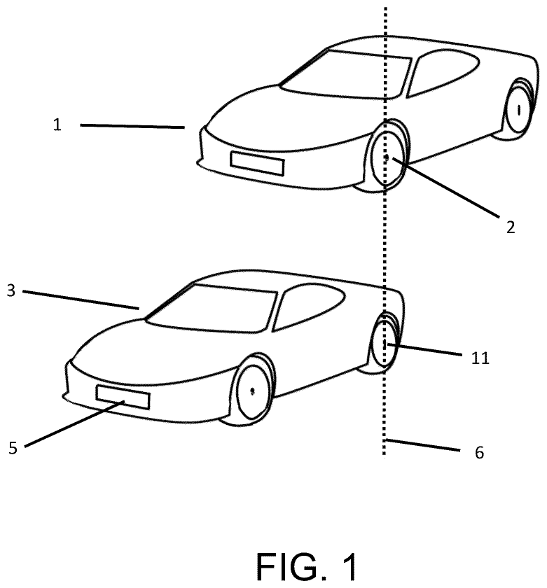

FIG. 1 exemplifies schematically one example of the method of the invention; and

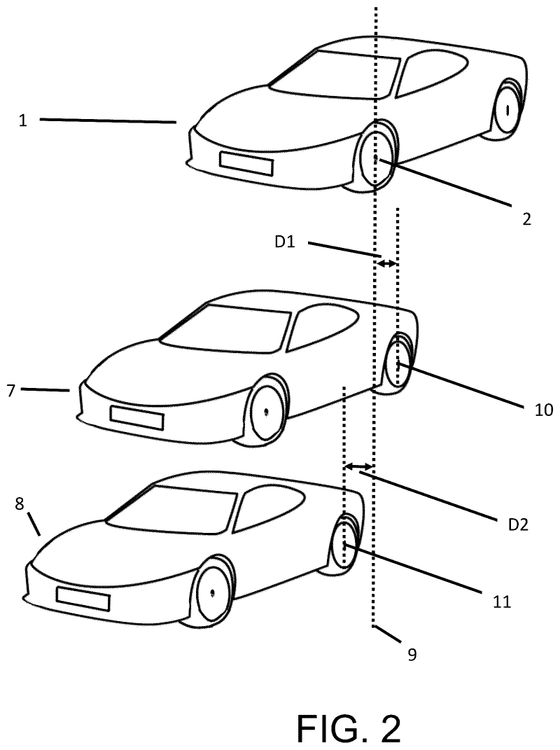

FIG. 2 exemplifies schematically a different example of the method of the invention.

In FIG. 1, a video capture of a vehicle is taken from the side, or an angle from which the side of the vehicle is clearly visible. Typically, this can be up to 60 degrees from directly side on, but it could be more. Two image frames from the capture as the vehicle moves across the field of view are shown in FIG. 1, vertically offset for clarity.

A technique known in the field of computer vision, for example a neural network, or a circle finder such as a circular Hough Transform, or a template matching algorithm is used to locate the centre point 2 of a front wheel in a first frame 1. The invention is not limited to locating the centre of a wheel. Various portions of each wheel may be used in this method [e.g., a leading portion or a trailing portion of each wheel] but locating the centre of each wheel is generally most convenient.

As the vehicle moves across the scene, both visible wheels on the near side are tracked until a subsequent frame is found 3 where the centre point of the rear wheel 4. has the same horizontal position 6 on the image frame as the centre point of the front wheel did in the first frame. Although the horizontal position is used in the example as a reference position, it is apparent that the invention is not limited to using a horizontal position as a reference. If a vehicle is moving obliquely away from an imaging device a vertical position on the image could be used, or indeed a point in the image could be used as the reference.

The time, T, between the first frame 1 and the second frame 3 is determined, either by counting the number of frames between the first and second frames, and using the frame per second measure of the capture to determine the interval between the frames, or more preferably by using the time measurement between each frame capture which most digital video capture devices record, as this gives a more accurate measurement and allows for any jitter in the frame capture rate, and summing them to measure the time elapsed between frames 1 and 3.

In that time elapsed the vehicle has travelled the distance between the wheel centres and so the speed of the vehicle can be calculated if this distance (the wheelbase) is known.

In this method, the wheelbase, W, of the vehicle is then determined, either because it is already known to the system, or from or in conjunction with one or more external sources. For example, the license plate of the vehicle 5 may be determined and searched for in a vehicle information database which contains the vehicle details e.g., the vehicle is a 2018 Ford Focus Mk4 Hatchback which has a wheelbase of 2.70 m. Further examples for identifying the wheelbase are given below.

The speed of the vehicle, V, between the frames 1 and 3 can then be determined by dividing the wheelbase by the time between the frames:

$$V = W / T \qquad EQ . 1$$

In practice, because the frames are captured at a discrete frame rate, the probability of a second frame having the rear wheel perfectly aligned with the front wheel is slim.

In this case a second technique can be used as exemplified in FIG. 2.

The location of the centre point 2 of a front wheel in a first frame 1 is found and its horizontal position 9 is measured and stored. The wheels are then tracked through the subsequent frames. A second frame 7 is identified as a frame (preferably the last frame) before the rear wheel has crossed the stored horizontal position of the front wheel, and a frame after that 8 (preferably the first frame) after the rear wheel has crossed the stored horizontal position of the front wheel.

The time at which the rear wheel crossed the stored horizontal position 9 of the front wheel can thus be determined by using:
the distance D1 between the position of the centre point 10 of the rear wheel in frame 7 and the stored horizontal position 9; and
the distance D2 between the position of the centre point 11 of the rear wheel in frame 8 and the stored horizontal position 9.

An interpolation technique known in the field, for example linear interpolation, can be used to determine the time at which the rear wheel crossed the stored horizontal position 9.

For example, using linear interpolation the crossing time of the rear wheel TC can be found from

$$TC = T 7 + ( T 8 - T 7 ) \times D 1 / ( D 1 + D 2 ) \qquad EQ . 2$$

where T7 is the time of frame 7, and T8 is the time of frame 8.

The difference between the time of frame 1, T1 and the interpolated rear wheel crossing time TC can then be used to calculate the vehicle speed, V in a similar manner as before:

$$V = W / ( TC - T 1 ) \qquad EQ . 3$$

In an alternative embodiment, the position of the rear wheel may be calculated first and used to create the fixed horizontal position and the front wheel crossing time calculated relative to that. In another embodiment, the frames either side of the front wheel may be found and interpolated between, rather than the rear wheel.

In another alternative embodiment, the horizontal position may not be fixed based on a position of either wheel in a specific frame, but determined using another criteria, and both the front and rear wheels crossing times determined using an interpolation technique.

Further, although tracking is indicated above, this need not be continuous. For example, it may be effective to:
identify a frame where a front wheel is shown and identify the centre or other portion of the wheel as a reference position.
identify another frame where the rear wheel is shown beyond that reference position.
to interpolate to identify a group of frames where the rear wheel is likely to have reached the reference position.
to identify among those frames which frame of frames best enables the determination of when the centre of the rear wheel reached the reference position.

In order to improve the robustness, several additional features may or may not be present.

The precise position of the centre (or other reference point) of the vehicle wheel is critical to the accuracy of the speed calculation. Techniques known in the field, for example finding the best line or lines of symmetry in the wheel portion of the image, or the best centre of rotational symmetry, or the best fit to a circle finder algorithm may be used to improve the accuracy of the wheel centre position. Finding another reference point on a vehicle wheel (for example leading edge or trailing edge of a wheel) is likely to be both less accurate and more difficult but is not excluded from the invention.

Several vehicles may be visible in the camera field of view, for example if it used in traffic or near parked vehicles. The wheels detected must therefore be matched to the vehicles they belong to.

The tracking of the wheels from frame to frame may be improved by using techniques known in the field e.g., projecting a velocity vector across the image to ensure that the estimated wheel position does not deviate from a physically viable line. Alternatively or additionally, a Kalman filter or similar predictor corrector algorithm may be used to estimate the positions of the wheels in each frame to improve tracking.

The difference in the velocity vectors of the front and rear wheels may be compared to a threshold to determine whether the tracked wheels are on the same vehicle (rather than being from different vehicles that are both in the field of view).

The velocity vectors of the tracked wheels may be compared to known viable trajectories to reject spurious tracking errors.

The images captured may be passed through a vehicle tracking algorithm, for example a deep neural net, which has been trained to recognise vehicles. The boundary or bounding box of the vehicle can then be used to match the wheels found in the image to the vehicle. The boundary of the vehicle can also be used to ensure that the license plate found is inside the vehicle boundary, and hence is from the same vehicle as the wheels that are tracked.

The license plate may be recognized and tracked over multiple frames and its velocity vector found. The velocity vector may then be compared to the velocity vector of the wheels and/or the vehicle to minimise the possibility that the licence plate is from another partially obscured vehicle. Other visual cues such as the colour of the vehicle in the region of the license plate and the wheels may be used to confirm the match.

A vehicle recognition neural net may also be trained to recognise vehicle types and models. In this case the recognised vehicle model may be used in conjunction with a library of vehicle wheelbases to determine the wheelbase, rather than using the license plate. The recognised vehicle type may also be compared to the vehicle type recovered from the license plate. If these do not concur then they may indicate either a misreading of the license plate, or a vehicle with fake or unregistered numberplates. In this case the information could be used to report to law enforcement.

The system may also perform aggregate calculations or summary reports. For example, it could record the proportion of vehicles in a given location that are exceeding the speed limit, or the highest speeds that are recorded in a given location.

The optic flow or movement of the regions of the image between the wheels may be measured and compared to the movement of the wheels to determine if they are all located on the same vehicle.

The angular rotation of the wheels in the image may be detected by image recognition, and knowledge of the diameter of the wheels used to convert the rotation in angular velocity to velocity along the road as a check against the value determined from the claimed method.

The method described may also track more than 2 visible near side wheels, for example from a 6 or more wheeled vehicle. In this case the detected wheels may be measured when crossing the fixed horizontal position and the distance between the different sets of axles used to determine the speed in the manner described previously. The algorithm may also track the position of 2 wheeled vehicles and measure their speed in the same manner as above.

In some instances, the wheelbase may not be precisely known, but bounds on the possible wheelbase lengths can be used to infer bounds on the possible speeds that the vehicle was doing.

The accuracy of the measurement will be affected by any movement of the camera between the frames used to measure the vehicle speed. If the camera is on a movable device (e.g., a handheld smartphone, or mounted on a pole that could be subject to oscillations, or in a vehicle or some other moving position), then the motion of the camera could be measured. This could be used to apply a correction to the vehicle speed measurement. Alternatively, the measurement could be rejected if the camera motion was above a threshold that would make the speed measurement insufficiently accurate.

The camera motion may be measured by accelerometers or gyroscopic sensors. Alternatively or additionally, the video capture may be analysed to measure camera motion. Portions of the image away from the vehicle target e.g., the top or bottom section of the image, where the image contains a fixed background object, can be used to measure the camera movement by calculating for example the optic flow of a background section of the image by a technique known in the field. The measured camera movement can then be used to either calculate a correction to the measured speed, or to reject the capture if the movement is above a threshold which would render the speed measurement insufficiently accurate.

The camera may also record location and time information, e.g., by GPS or some other manner, to provide evidence of the time and location the speed was measured.

The location information may be combined with data on speed limits in the location to determine if a speeding offence has taken place.

When the camera location is close to a road junction, it may be ambiguous from the location alone, and also the error on the GPS position, which road the vehicle is travelling on. If this is the case, the compass heading of the capture device or a pre-programmed setting, may be used to determine which road the vehicle is travelling on. The angle and direction of the vehicle motion across the field of view may also be used to determine which road the vehicle is travelling on. For example, on a crossroads with one road passing East-West and one North-South, if the camera is facing NE, if the vehicle wheels travel up and left in the image, the vehicle is travelling East on the East-West road. If they are travelling up and right, they are travelling North on the North-South road, down and left, they are travelling South and down and right, they are travelling West.

The video data, and/or associated metadata, may be digitally signed by a method known in the field e.g., hashing, to demonstrate that the data has not been tampered with.

The timing signals from the capture device may also be recorded and compared to a known calibrated time to detect any errors in the timing measurements on the device.

The capture frames may be recorded and annotated with the tracked wheel position and timestamp of the frames and used to present as evidence of the vehicle speed.

The speed of the vehicle can be measured using two or more reference positions on the image and the acceleration of the vehicle estimated from the change in speed at each image position, and the time between a vehicle wheel reaching each position.

Other possibilities for the disclosed methods will be apparent to the person skilled in the art, and the present invention is not limited to the examples provided above.

### DESCRIPTION OF THE NEW FEATURES AND INVENTIONS

Further features are evident from the following with reference to the drawings in which:

FIGS. 1 and 2 are as presented in the earlier application;

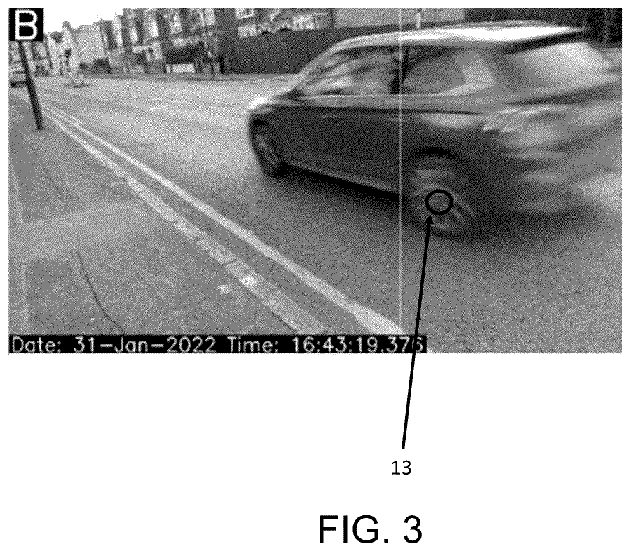

FIG. 3 shows annotation of a capture frame to show a portion used for speed estimation;

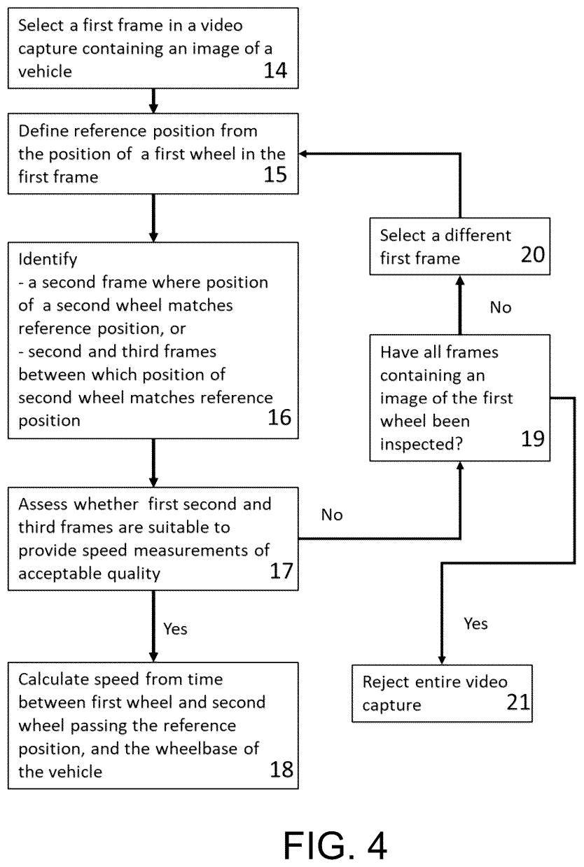

FIG. 4 shows a flowchart based on wheel position measurement;

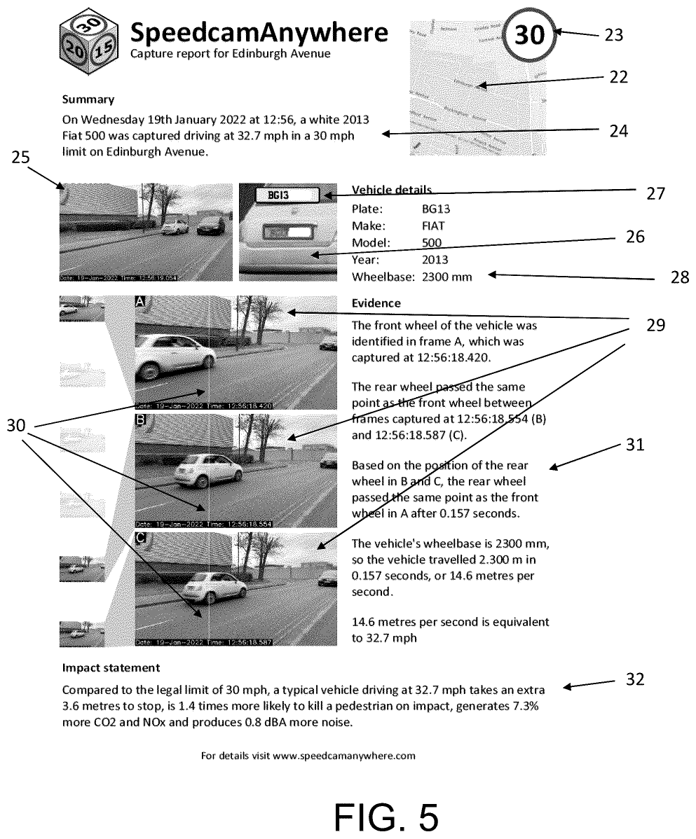

FIG. 5 illustrates an example report producible with the system of the invention;

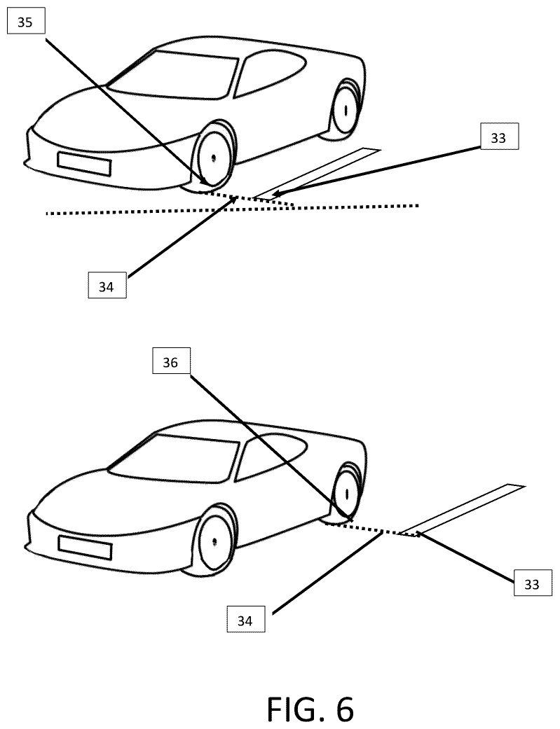

FIG. 6 illustrates determination of an appropriate datum line;

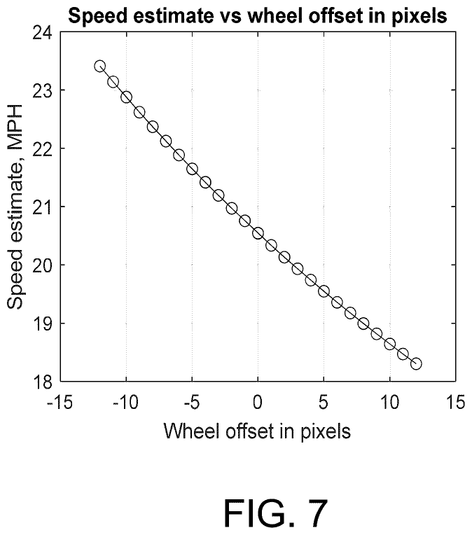

FIG. 7 shows the relationship between pixel offset and the resulting speed estimate using values from a real-world example; and

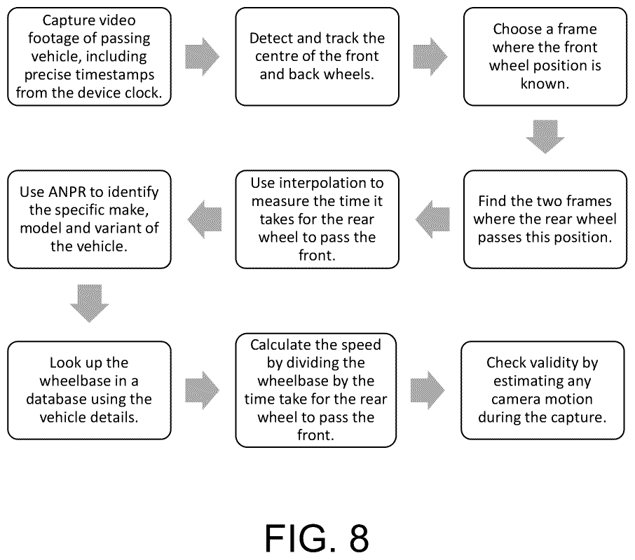

FIG. 8 shows a process flow for a system in accordance with the present invention.

### ANNOTATION OF IMAGES

As indicated in the earlier application, capture frames may be recorded and annotated with a tracked wheel position and timestamp of the frames and used to present as evidence of the vehicle speed. Annotation of images can also be used for quality control purposes. For example, one or more capture frames may be annotated with an indicator showing a vehicle portion used in calculation of vehicle speed. The indicator may define an area encompassing the vehicle portion, the area being defined by a predetermined speed tolerance. The speed tolerance need not be symmetrical, as an underestimate of a speeding vehicle's speed is not as serious as an overestimate of the speed of a vehicle observing applicable speed limits.

This is exemplified with reference to FIG. 3, and to use of the wheel centre as the vehicle portion used in speed measurement, but the method is applicable to other vehicle portions. FIG. 3 shows a capture frame of a vehicle 12. The frame is annotated with an indicator 13 showing a wheel used in calculation of vehicle speed [in this example the centre of a wheel as identified by the system is used for calculation of vehicle speed]. The indicator 13 lets anyone inspecting the frame confirm that the speed measurement is based on a correctly identified vehicle portion.

The indicator 13 is scaled to define an error tolerance such that if the centre of the wheel is within the circle, then the speed error is less than a defined threshold (+/−2 mph (˜3.2 kph) in FIG. 3). The indicator 13 is shown as a circle but other forms can be used [e.g., separate lines indicating an upper and lower threshold].

To calculate the wheel centre threshold, the system defines a speed tolerance (e.g., +2 mph), then calculate the offset, in pixels, which would correspond to an error of this speed. If the vehicle is moving left to right, this tolerance would correspond to moving the estimated front wheel position x pixels to the left and both estimated rear wheel positions x pixels to the right, which would result in an increase in the speed estimate. Conversely, moving the front wheel position x pixels to the right and both rear wheel positions x pixels to the left would result in a decrease in the speed estimate.

In order to calculate a tolerance for the horizontal wheel centre position in pixels, the estimated position of the front wheel, x_{front}, rear wheel in the frame before it passes the front wheel position, xᵣₑₐᵣ₀, and rear wheel in the subsequent frame, xᵣₑₐᵣ₁ are determined, along with the corresponding timestamps of these frames, t_{front}, tᵣₑₐᵣ₀ and tᵣₑₐᵣ₁. The wheelbase of the vehicle, wb, also needs to be know at this stage. Assuming the rear wheel travels at a constant speed in the horizontal direction in the time between the two frames, linear interpolation gives the time difference dt as:

$$dt = {t}_{rear 0} + ( {t}_{rear 1} - {t}_{rear 0} ) \frac{{x}_{rear 0} - {x}_{front}}{{x}_{rear 0} - {x}_{rear 1}} - {t}_{front} \qquad EQ . 4$$

The nominal speed, s₀, is then calculated simply by:

$${s}_{0} = \frac{wb}{dt}$$

Firstly, a new dt that corresponds to a real-world speed of the nominal speed minus the defined tolerance, t_{speed}, is calculated as follows:

$${dt}_{new} = \frac{wb}{{s}_{0} - {t}_{speed}} \qquad EQ . 5$$

To find a shift in pixels that would result in this new dt, we first define this to be a shift in pixels that would simultaneously move the front wheel away from the last rear wheel, and both rear wheels in the opposite direction. This would yield the largest possible estimate of dt and therefore the smallest speed measurement for a given pixel tolerance. We can modify Equation 4:

$${dt}_{new} = {t}_{rear 0} + ( {t}_{rear 1} - {t}_{rear 0} ) \frac{( {x}_{rear 0} + \partial ) - ( {x}_{front} - \partial )}{{x}_{rear 0} - {x}_{rear 1}} - {t}_{front} \qquad EQ . 6$$

where ∂ is the shift in pixels we want to determine. Note that the denominator of the fraction doesn't change because we are moving both rear wheels by the same distance in pixels. Rearranged with respect to ∂ gives us:

$$\partial = \frac{( {x}_{rear 0} - {x}_{rear 1} ) \frac{( {dt}_{new} + {t}_{front} - {t}_{rear 0} )}{{t}_{rear 1} - {t}_{rear 0}} - {x}_{rear 0} + {x}_{front}}{2} \qquad EQ . 7$$

It should be noted that, because speed is proportional to 1/dt, pixel offset does not have a linear relationship with speed, meaning that a pixel offset in one direction that corresponds to a 2-mph speed increase does not correspond to a 2 mph decrease when in the other direction. This means that if the wheel centre is within tolerance bounds, we could be underestimating the actual speed by up to 2 mph, but there is a lower limit on how much we could be overestimating speed. The FIG. 7 shows the relationship between pixel offset and the resulting speed estimate using values from a real-world example of a vehicle travelling at ˜20 mph:

This tolerance can be indicated graphically on the capture frame as a region within which the centre of each wheel must lie in order for the measurement to be within the specified tolerance. This can then be manually confirmed by the operator.

Additionally, the camera may be subject to shake. This can be measured as described above, by taking the optic flow or a similar measurement of the background movement (in pixels) and applying a threshold to reject movement that may cause the capture to be out of tolerance.

In practice, the shake is likely to be a rotation, θ, rather than a translation. In an outdoor image, generally the bottom part of the image will be closer to the camera, the subject in the centre will be farther away, and the top part of the image will be the furthest away. This means for a given θ, the pixel translation will be proportional to θr, where r is the distance to the part of the 3D scene where the corresponding image translation is being measured. In the absence of a detailed 3D representation of the scene with knowledge of r across the image, what can be assumed is that the pixel shift in the top part of the image will be larger than the pixel shift in the centre and bottom. Thus, we can apply a tolerance on the pixel shift in the upper section of the image (the sky, or buildings in the background) and be confident that the pixel shift of the subject (the vehicle) is less than the shift at the top.

The pixel tolerance for the image shift can be the same as that used for the wheel centre tolerance, or some function of it. The two error sources (camera shake and wheel centre position) will compound and if they are both in the same direction, which will increase the error in the speed estimate. To avoid this, the allowable pixel error for a given speed can be split between the two sources of error. For example the maximum allowable pixel shift due to camera shake can be X % of the total allowable pixel error and the wheel position tolerance can be (1−X) % of the total allowable error where X is a number between 0 and 1. Alternatively the pixel shift due to camera shake can be measured, and then that shift can be used to adjust the tolerance on the wheel centre position, for example it could be subtracted from it. The frame annotation showing the wheel centre tolerance can be based on any of the above options.

In another alternative, the camera shake tolerance in pixels can be shown on the frame annotation, for example as a marker showing how much the background image can be allowed to move by between the front and rear wheel frames, and whether the movement is less than this can be confirmed by an operator.

In an alternative embodiment, the system may be designed so that is accepts the measurement from a moving camera and compensates the measurement for the camera movement. If the movement can be assumed to be purely translational, and the movement in pixels can be used to move the datum line in either or both of the images by a corresponding amount, so that the datum line remains approximately fixed in the scene.

In the general case, the movement cannot be assumed to be purely translational (for example if the measurement was taken from a moving vehicle which could rotate and translate, a more accurate movement compensation would be beneficial.

Because the 3D geometry of the scene is not known with precision, an estimate of the movement of an appropriate datum line can be calculated using the process shown in FIG. 6.

A distinct feature 33 is found in the image background scene, for example the edge of a road marking. This could be anything static in the scene, but preferably it would be close to the track that the vehicle wheels follow, and in front of the vehicle such as a road marking, manhole cover etc. A datum line 34 is then projected in the image from the chosen distinctive feature that crosses the path of the vehicle. The angle of this line in the image could be horizontal or vertical, or another defined angle. Preferably it would be an angle that is perpendicular to the path of the vehicle in the plane of the road surface. This angle can be estimated by taking a distinct feature on the vehicle that horizontally crosses the vehicle, for example a number plate, rear window edge or bumper and using the angle that takes across the image.

Using the wheel position found as described previously, the frame in which a known point 35 on the front wheel crosses the datum line is found. This could be the centre of the wheel, or another readily measurable point on the wheel, for example the bottom of the wheel, or the centre of the contact point with the road.

A second frame is then found where a known point 36 on the rear wheel crosses the datum 34, projected from the position of the same scene 33 feature in the second frame using either the same angle, or an angle rederived using a similar measure. The wheelbase of the vehicle divided by the time between the first and second frames can then be used to the determine the speed of the vehicle as in the previous method.

In practice, the front and rear wheels are unlikely to perfectly align with the datum line 34 in any frame. In this case the frame just before the wheel crosses the line and the frame just after is found, and the time that the wheel crossed the line is found by interpolation as previously described.

If this method is used, the frames can also be annotated with the construction lines used—the datum, the scene feature, the wheel position-so the measurement can be validated or used for evidence.

The invention provides a method as claimed in any claim of the earlier application, or as described herein, where the motion of the imaging device is compensated for by:
Locating a feature in the image scene that the vehicle passes during the capture.
Defining a datum position from that feature in different images, such that the datum position in each image corresponds to an approximately stationary position in the real scene.
Measuring the time that the front and rear wheels cross the datum position.
Using the time that the front and rear wheels cross the moving datum to derive the speed.

### Quality and Presentation of Speed Measurements

The earlier application suggested rejection of captures if camera motion was above a threshold that would make the speed measurement insufficiently accurate.

A capture that would be rejected based on one set of frames may have another set of frames that do not have this defect and so the present invention may use frame-by-frame analysis to select a group of frames that are suitable for providing a speed measurement within acceptable tolerances. For example, if 7 frames are required to get the speed, the systems select a 7-frame section of the video where the motion was below a defined tolerance to do the calculation, rather than reject the whole capture.

FIG. 4 illustrates schematically one exemplary flowchart based on wheel position measurement. Boxes 14,15, 16 and 18 conform to the basic scheme of the earlier application. Box 17 is directed to assessing whether the identified frames of a video capture are suitable for providing speed measurements of acceptable quality. If they are acceptable then the speed is calculated [Box 18]. If not acceptable then either a different set of frames is identified [Box 20], or if all frames containing an image of the first wheel have been inspected without revealing an acceptable set of frames [Box 19], then the whole video capture is rejected [Box 21].

In the alternative, if no acceptable set of frames is identified, then the best set found can be used to calculate speed, and annotated with a warning that the speed is outside the defined tolerances of the system.

An alternative approach to that shown in FIG. 4 is to first analyse the video capture for sets of frames showing camera motion below a threshold and then do the speed analysis based on those sets.

Other criteria for rejecting frames may optionally be applied. For example, it may be desirable to select a group of frames where the vehicle license plate is visible in at least one of the frames from which the speed is calculated. Ideally the vehicle license plate should be visible in all the frames from which the speed is calculated so that images can be presented showing the vehicle and license plate at the beginning frame and end frame used for calculation of vehicle speed. The error in the speed estimate is proportional to the error in the measured wheel centre position (in pixels) divided by the wheelbase of the vehicle in the image (in pixels). This means that errors will be higher when the wheelbase, as viewed in the image, is smaller. It may therefore be desirable to filter image frames where the wheelbase appears shorter, for example when the vehicle is far away from the camera, or the angle that is travelling to relative to the direction the camera is pointing gets closer to zero degrees.

Other criteria for accepting or rejecting frames may therefore be optionally applied. For example, the length that the wheelbase subtends in the image may be thresholded, such that vehicles that are too far away will not be tracked, as pixel resolution may then cause a material error in the speed estimate. Another optional example may be rejecting frames where the angle of the vehicle relative to the camera is sufficiently acute that an error in the location of the pixel is material. This could be done be different means, for example inferring it from the wheelbase as seen in the image, or changes in the wheelbase as seen in the image, or how elliptical the wheel appears in the image, or other geometric cues.

Another option may be to use only frames which have only intraframe compression, and do not have interframe compression to avoid any uncertainty regarding the accuracy of pixel position that could result from interframe compression and decompression.

An additional optional feature is for any hardware or device that is used to capture the images or video to use in this technique is to either use an external clock source to timestamp the frame capture times, or to validate its internal clock or oscillator against a secondary source. The secondary source use for validation could be internal, for example if the capture takes place in a device with multiple clocks or oscillators, it could compare the accuracy of these either at the time of capture or at other intervals. The device may also compare its accuracy with an external clock on a remote device or server. For example, extremely accurate reference times are available over the internet from Network Time Servers. Alternatively, they may use a GPS time signal to either timestamp the images or to compare the accuracy of their internal clock with that provided by the GPS signal.

In one possible embodiment, the device requests a timestamp from an external source. This could be corrected for using a technique known in the field for example the Network Time Protocol standard to allow for the latency in the request, or another technique. The device then marks the time as stated by its internal clock. After taking a capture or at some other time, the device then requests a second timestamp from the external source. The difference in elapsed duration as measured by the internal and external sources can then be used to measure a maximum error in the internal clock accuracy. This can then be used to reject captures if the clock is sufficiently inaccurate that the speed error may be above a threshold.

In another possible embodiment, the device requests repeated external timestamps and uses them to timestamp each image captured.

An additional optional feature could be to measure the distance between vehicles to detect vehicles driving too close for the speed they are travelling at. This could be achieved as follows. Track multiple vehicles passing the image. Measure the wheel tracks and velocities of the vehicles as described. For pairs of vehicles where the wheel tracks have sufficiently similar vectors, measure the distance between the vehicles by using the wheelbase as a scaling measure to determine the distance between the vehicles.

In an additional optional feature, the evidence may be used to automatically issue penalties if speeding offences are detected.

The present invention can be useful to present information in graphical format [on screen or otherwise] and FIG. 5 illustrates an example report producible with this system.

In a summary portion, the report graphically identifies the location 22 and relevant speed limit 23 and provides a summary conclusion 24 concerning the speed of the vehicle in relation to the applicable speed limit.

A vehicle identification portion shows an image 25 of the vehicle in question permitting human comparison with the road identified. A close up 26 of the part of the image containing the vehicle license plate is shown and superposed on this is the system recognised license plate number 27 to allow human comparison to confirm the identification of the license plate.

A vehicle characteristic portion 28 shows the recognised license plate, the vehicle make, model, and year, and the vehicle wheelbase, these being retrieved from relevant databases using the license plate. This information permits human comparison with the image to confirm that the vehicle shown matches the license plate.

An evidence portion shows the frames 29, bearing date stamps, which were used in the speed calculation. Indicators 30 show the reference position defined by the front wheel centre in the first frame. This permits human comparison with the images to ensure that the identification of the wheel centres is appropriate. A summary portion 31 shows the calculation used in assessing vehicle speed.

An impact statement portion 32 shows the effect of speeding—in this case indicating added risk to pedestrians, added pollution, and added noise. Other impacts could be added [e.g., increased fuel consumption, increased cost of journey] as appear appropriate. From vehicle data and speed all of these variables can be calculated.

Other variables that might be presented as relevant evidence include local weather conditions and visibility [from weather apps or from sensors on the capture device].

### Impact of Public Availability of Reliable Speed Measurement

Vehicle speed measurement has traditionally been done using fixed equipment or specialised devices. By placing the ability to measure vehicle speed reliably in the hands of anyone that owns a mobile phone with a camera, the present invention opens up new possibilities for road safety and enforcement.

A mobile phone (or other portable device with camera and internet connection) running a reliable speed measurement app can interact with other devices and so be used to provide added safety and information to others.

For example, the device may report a speeding vehicle to relevant authorities. Reporting may be inhibited where the speed is below a threshold, for example a vehicle travelling slightly above the relevant speed limit may be tolerated where higher speeds are not. The geographical location may be used to determine the relevant authority, and the threshold may be determined by the authority. Reporting may be at user choice, or automatically.

The device may retrieve information concerning variable speed limits where the relevant authority imposes such. For example, different speed limits may be applicable to a location during the day for many reasons, including to cope with heavy traffic times, or school leaving times. In addition, temporary speed limits may be imposed for road works and so what constitutes speeding may change from one day to the next, or even one hour to the next.

The device may provide an alert of speeding vehicles directly or indirectly to relevant static speed cameras to permit checking by authorities. By relevant static speed cameras is meant speed cameras located in the general direction of travel of the speeding vehicle, or a wider area if determined by relevant authorities.

The device may provide an alert of speeding vehicles to relevant users of mobile devices as a warning and/or a request for further speed measurements. By relevant users is meant users of mobile devices whether with or without speed measurement capability, located in the general direction of travel of the speeding vehicle, or a wider area if required. A collection of speed measurements from independent devices may be used to compare the speed measured by two or more devices, and optionally the time taken for travel between devices, to provide further evidence of consistent speeding.

The device may alert registered vehicle owners that their vehicle has been seen speeding [useful for anxious parents and owners of vehicle fleets].

The device may communicate with electronic devices on speeding vehicles (e.g., sound system or driver's mobile device) to provide a warning of speeding.

A process flow for the system is shown in FIG. 8 [ANPR is an acronym for Automatic Number Plate Recognition].

1. A method for determining the speed of a vehicle in a video sequence from an imaging device, comprising:
a. capturing frames from the video sequence;
b. determining a time elapsed between a first vehicle portion reaching a reference position in one or more first capture frames and a second vehicle portion reaching the reference position in one or more second capture frames;
c. calculating vehicle speed based on knowledge of the distance between the vehicle portions and the time elapsed; and
d. annotating one or more of the capture frames with an indicator of at least one of the vehicle portions used to determine the time elapsed.

2. A method as claimed in claim 1, in which the indicator is provided in at least one of said first capture frames and at least one of said second capture frames.

3. A method as claimed in claim 2, in which the indicator comprises an area encompassing the vehicle portion, the area being defined at least in part by a predetermined speed tolerance.

4. A method as claimed in claim 3, in which the area is calculated by determining a pixel displacement corresponding to the speed tolerance.

5. A method as claimed in claim 4, further comprising determining the motion of the imaging device between the one or more first capture frames and the one or more second capture frames and adjusting the size, nature, and/or position of the indicator to provide information on extent of imaging device motion.

6. A method as claimed in claim 5 in which motion of the imaging device during capture is compensated for by:
e. locating a scene feature in the capture frames that the vehicle passes during the capture;
f. defining a datum position from that feature in different capture frames, such that the datum position in each of those different capture frames corresponds to an approximately stationary position in the real scene; and
g. using the datum position as the reference position.

7. A method for determining the speed of a vehicle in a video sequence from an imaging device, comprising:
a. capturing frames from the video sequence;
b. locating a scene feature in the capture frames that the vehicle passes during the capture;
c. defining a datum position from that feature in different capture frames, such that the datum position in each of those different capture frames corresponds to an approximately stationary position in the real scene;
d. determining a time elapsed between a first vehicle portion reaching the datum position in one or more first capture frames and a second vehicle portion reaching the datum position in one or more second capture frames; and
e. calculating vehicle speed based on knowledge of the distance between the vehicle portions and the time elapsed.

8. A method as claimed in claim 7, wherein the datum position comprises a line at an angle extending perpendicularly to the path of the vehicle.

9. A method as claimed in claim 8, wherein a distinct feature on the vehicle that horizontally crosses the vehicle is used to determine the angle.

10. A method as claimed in claim 9, further comprising annotating one or more of the capture frames with the datum position, and optionally the scene feature.

11. A method as claimed in claim 10, wherein the one or more first capture frames and one or more second capture frames are part of a group of capture frames and the vehicle license plate is visible in at least one of group of capture frames.

12. A method as claimed in claim 11, wherein the capture frames are filtered to reject or annotate as unreliable capture frames where a distance subtended between the vehicle portions is less than an image size threshold.

13. A method as claimed in claim 12, wherein the capture frames are filtered to reject or annotate as unreliable capture frames wherein the angle of the vehicle relative to the camera is sufficiently acute to exceed an angle threshold.

14. A method for determining the speed of a vehicle in a video sequence from an imaging device, comprising:
a. capturing frames from the video sequence;
b. determining a time elapsed between a first vehicle portion reaching a reference position in one or more first capture frames and a second vehicle portion reaching the reference position in one or more second capture frames;
c. calculating vehicle speed based on knowledge of the distance between the vehicle portions and the time elapsed; and
d. filtering the capture frames to at least one of reject capture frames where a distance subtended between the vehicle portions is less than an image size threshold and
to reject or annotate as unreliable capture frames wherein the angle of the vehicle relative to the camera is sufficiently acute to exceed an angle threshold.

15. A method as claimed in claim 14, wherein the capture frames are filtered to reject or annotate as unreliable capture frames having interframe compression.

16. A method as claimed in claim 15, in which the imaging device uses an external clock source to timestamp the frame capture times.

17. A method as claimed in claim 16, in which the imaging device has an internal clock or oscillator which is validated against a secondary source.

18. An imaging device configured to determine the speed of a vehicle in a video sequence from an imaging device, wherein the imaging device is programmed to:
a. capture frames from the video sequence;
b. determine a time elapsed between a first vehicle portion reaching a reference position in one or more first capture frames and a second vehicle portion reaching the reference position in one or more second capture frames;
c. calculate vehicle speed based on knowledge of the distance between the vehicle portions and the time elapsed; and
d. annotate one or more of the capture frames with an indicator of at least one of the vehicle portions used to determine the time elapsed.

19. An imaging device configured to determine the speed of a vehicle in a video sequence from an imaging device, wherein the imaging device is programmed to:
a. capture frames from the video sequence;
b. determine a time elapsed between a first vehicle portion reaching a reference position in one or more first capture frames and a second vehicle portion reaching the reference position in one or more second capture frames;
c. calculate vehicle speed based on knowledge of the distance between the vehicle portions and the time elapsed; and
d. filter the capture frames to at least one of reject capture frames where a distance subtended between the vehicle portions is less than an image size threshold and to reject or annotate as unreliable capture frames wherein the angle of the vehicle relative to the camera is sufficiently acute to exceed an angle threshold.
